(19) United States
(12) Patent Application Publication
(10) Pub. No.: US 2015/0199651 A1
(43) Pub. Date: Jul. 16, 2015

(54) Integrated Online Time and Place Management

(71) Applicant: Tiruvilwamalai Venkatraman Raman, San Jose, CA (US)

(72) Inventor: Tiruvilwamalai Venkatraman Raman, San Jose, CA (US)

(21) Appl. No.: 11/557,104

(22) Filed: Nov. 6, 2006

(51) Int. Cl. G06Q 10/10

(52) U.S. Cl. CPC G06Q 10/1095

(57) ABSTRACT

A computer-implemented method invokes a task when a respective event in a respective user's calendar meets predefined criteria. The method furthermore includes receiving from the task information identifying a second event related to the respective event, and adding the second event to the respective user's calendar. For example, invoking the task may include accessing an application for making travel arrangements, and adding the second event to the user's calendar may includes adding a travel event to the user's calendar. In another example, invoking the task may include invoking a contact application for managing a set of contacts of the respective user. In this example, at least some of the contacts in the respective user's contact list have contact locations.

### TECHNICAL FIELD

The disclosed embodiments relate generally to electronic calendar systems. More particularly, the disclosed embodiments relate to methods, systems, user interfaces and data structures for generating, transmitting and rendering event, presence and location information on an electronic calendar, contact list or map within an integrated time and place management system using time and place information and extensible personalized rules.

### BACKGROUND

While electronic calendars, including online calendars, are highly useful applications, the event information in a user's electronic calendar is often duplicative of event information the user has entered or generated using one or more other applications (e.g., an application for making travel arrangements or an application for buying tickets to an event). It would be highly desirable if the event information generated by other applications could be automatically added to a user's calendar, thereby relieving the user of the need to manually re-enter the event information into the calendar. In addition, it would be desirable for other applications to be able to use the information in a user's calendar to assist with the planning of related events. Furthermore, it would be desirable for the sharing of information between a calendar application and other applications to be personalized in accordance with user selections or actions made in the past. For a better understanding of the aforementioned aspects of the invention as well as additional aspects and embodiments thereof, reference should be made to the Detailed Description of Embodiments below, in conjunction with the following drawings, in which like reference numerals refer to corresponding parts throughout the figures.

### SUMMARY

In accordance with some embodiments, a computer implemented method provides integrated time and place management for a user. The method includes invoking a task if an event in the user's calendar meets predefined criteria; receiving, from the task, information identifying a second event related to the first event; and adding the second event to the user's calendar.

In accordance with some embodiments, a system for integrated time and place management includes memory, one or more processors, and one or more programs stored in the memory and configured for execution by the processors. The programs include instructions for evaluating an event associated with a calendar, invoking a task if the event meets predefined criteria, receiving, from the task, information identifying a second event related to the first event, and adding the second event to the calendar.

In accordance with some embodiments, a computer program product for use in conjunction with a computer system, where the computer program product includes a computer readable storage medium and a computer program mechanism embedded therein. The computer program mechanism comprises instructions for evaluating an event associated with a calendar, for invoking a task if the event meets predefined criteria, for receiving, from the task, information identifying a second event related to the first event, and for adding the second event to the calendar.

### BRIEF DESCRIPTION OF THE DRAWINGS

FIG. 1 is a block diagram illustrating an exemplary distributed computer system for implementing some embodiments disclosed herein.

FIG. 2 is a block diagram illustrating relationships between elements described herein.

FIG. 3 is a block diagram illustrating an exemplary user database and an exemplary user record.

FIG. 4A is a flow chart illustrating an exemplary method.

FIG. 4B is a flow chart illustrating a second exemplary method.

FIG. 4C is a flow chart illustrating a third exemplary method.

FIG. 5 is a block diagram illustrating an exemplary client.

FIG. 6 is a block diagrams illustrating an exemplary server.

### DETAILED DESCRIPTION OF EMBODIMENTS

Methods, systems, computer programs, and other aspects of the invention are described. Reference will be made to certain embodiments of the invention, examples of which are illustrated in the accompanying drawings. While the invention will be described in conjunction with the embodiments, it is not intended to limit the invention to these particular embodiments. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks well known to those of ordinary skill in the art are not described in detail to avoid obscuring aspects of the present invention.

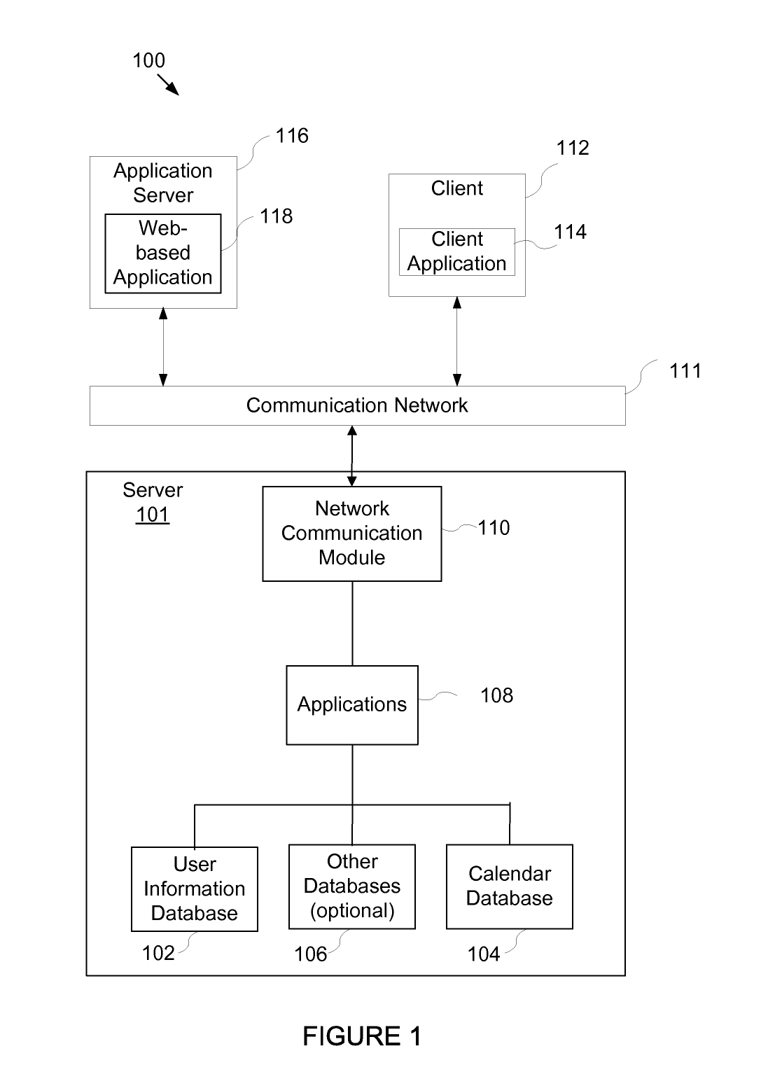

FIG. 1 is a block diagram of a system 100 for implementing some embodiments disclosed herein. The system 100 may include a server system 101 connected, via a communications network 111, to various devices, including one or more client devices or computers 112 (hereinafter “clients”), and an application server 116.

The server system 101 may include various databases 102-106, applications 108 and a network communication module 110. The databases may include a user information database 102, a calendar database 104, and optionally, other databases 106 as well. The user information database 102 may store user information associated with each user of the system. User information database 102 can include user profiles, user contact lists, user identifiers (hereinafter “user IDs”) and rules associated with the users. A respective user profile can include a default location, travel preferences, history, communication preferences, inferred availability (e.g., availability of the user to receive telephone calls), and inferred locations (e.g., locations of the user at various points in time). The calendar database 104 may store calendar information associated with one or more user calendars. Calendar information can include data associated with a particular event in a user's calendar, such as event time, event date, event location, event description, event attendees and event invitees. Calendar information can also include geographical location information (sometimes herein called geocoding), such as one or more geocodes, to supplement the event location information for an event. Other databases 106 could include, for example, a location database, a contact database, or a database used by any of the applications 108.

The server system 101 may also include various applications 108 on the server. The server applications 108 may read and write data to and from the databases 102-106. The applications 108 may include a calendar application; a location inference program; mapping applications; a user preference inference program; a user information processing module; a contact management application; electronic communication applications, such as e-mail, chat, pager, instant messaging, and/or voice communication applications, or any subset or superset of such applications, as needed for a particular embodiment.

The server system 101 may also have a network communication module 110 connecting it to the communication network 111 and facilitating communication between the server system 101 and the communication network 111. The network communication module 110 allows for the transfer of information between the server system 101 and the communication network 111. The transferred information may be displayed on the client application 114 of the client 112. The applications 108 may be connected to the network communication module 110. The network communication module 110 may allow the databases 102-106 and the applications 108 to transmit and receive information via the communication network 111.

The communication network 111 may be a local area network (LAN), a metropolitan area network, a wide area network (WAN), such as an intranet, an extranet, or the Internet, or any combination of such networks. It is sufficient that the communication network 111 provides communication capability between the client 112 and the server system 101. In some embodiments, the communication network 111 uses HyperText Transport Protocol (HTTP) to transport information using the Transmission Control Protocol/Internet Protocol (TCP/IP). The HTTP permits a client 112 to access various resources available via the communication network 111. The various embodiments of the invention, however, are not limited to the use of any particular protocol. The term “resource” as used throughout this specification refers to any document, object, information item, set of information, web-based application or service that is accessible via a Uniform Resource Locator (URL) and can be, for example, a web page, a text or word processing document, an email message, a voice message, a database, an image, or a computational object.

At least one client 112 may also be connected to the communication network 111. The client 112 may be any of a number of devices (for example, a computer, an internet kiosk, a personal digital assistant, a cell phone, a desktop computer, or a laptop computer) and can include a client application 114 that permits a user to view various resources. The client application 114 may be a software application that permits a user to interact with the client 112 and/or network resources to perform one or more tasks. For example, the client application 114 may be a web browser (for example, the computer programs available under the trademarks Firefox®, Internet Explorer® or Safari™) or other application that permits a user to search for, browse, and/or use resources, such as one or more web pages, on the client 112 and/or accessible via the communication network 111.

Various other applications and databases may also reside on the client, including some or all of those listed above as applications 108 and databases 102-106. In some embodiments for example, rather than be included in the user information database 102 of server system 101, a user profile may reside, in whole or in part, on the user's client 112.

In addition, at least one application server 116 may be connected to the communication network 111. The application server 116 may host at least one online application 118 (sometimes called a “web-based application”). The online or web-based application 118 may be any application that performs services for clients 112 and communicates with the clients 112 via a communication network 111. For example, the online or web-based application 118 may be a travel application for searching, scheduling or booking travel arrangements such as airline flights, hotels, rental cars or the like.

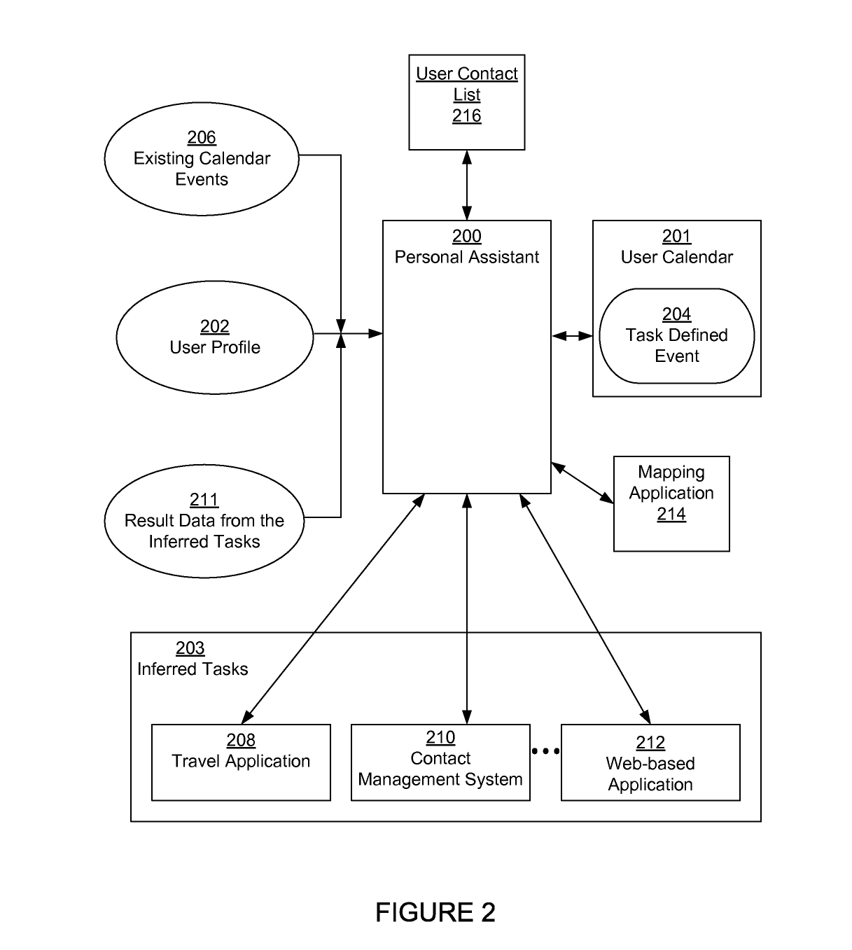

The system 100 allows user information and calendar data to be exchanged between various applications, such as an electronic calendar and a travel application. In particular, as shown in FIG. 2, information from a user profile 202 can be combined with historical data, such as existing calendar events 206 and result data from previously inferred tasks or subtasks 211, to infer and invoke tasks 203 and add events 204 to the user's calendar 201 based on the results of those inferred tasks. This process is managed by a computer-implemented method, program or application herein called a personal assistant 200.

The personal assistant 200 uses information from the user profile 202 and existing calendar events 206 to infer one or more tasks 203. The set of events 206 accessible to the personal assistant 200 may include the set of all existing calendar events, or a subset thereof. As explained below, a respective calendar event may trigger the personal assistant 200. In some embodiments, the personal assistant 200 may also use result data from previously inferred tasks or subtasks 211. The personal assistant 200 includes an inference engine that can infer tasks, locations, availability, user preferences and the like according to a customizable set of rules. The personal assistant 200 infers a task (i.e., infers that a task should be executed) by evaluating historical data, such as the user profile 202, the existing calendar events 206 and result data 211 according to a set of customizable inference rules. Based on the user profile 202, existing calendar events 206 and result data 211 or other user information the inference rules may be customized.

The inferred tasks 203 may invoke a travel application 208 for making travel arrangements, a contact management system 210 for identifying and communicating with user contacts, or any online or web-based application 212 capable of transmitting and receiving data. These applications are invoked in order to perform the inferred task 203 or a subtask thereof. In addition, the inferred tasks 203 may require invoking multiple instances of the same application to complete all of the subtasks of an inferred task 203. The applications 208, 210 and 212 may be invoked automatically by the personal assistant 200 or upon user confirmation of the personal assistant's inference.

The personal assistant 200 may compare data and metadata from a respective calendar event submitted by the user, such as event location and time, with other existing calendar events 206 and/or the user's profile 202 to infer a task 203 and/or to compute whether additional subtasks are needed to complete the inferred task 203. For example, if a user profile 202 includes a default location in California and the user submits a calendar event 206 having an event location in New York, the personal assistant 200 may infer a travel task 203 by comparing the user default location with the event location. The customizable inference rules may include, for example, requiring that a travel application 208 be invoked when the user default location and the event location differ according to predefined criteria. Alternatively, according to one set of rules, the personal assistant 200 may offer to invoke the contact management system 210 to communication with a contact located near the event.

The personal assistant 200 also can invoke a mapping application 214. For example, the mapping application 214 may be invoked to determine the geocoding (e.g., geocode(s)) specifying an event location or locations identified only by general textual information, such as a place name, street address or the like and to determine the distance between locations. The geocoding may then be added to the event location. The mapping application 214 may also be invoked to display results associated with the inferred tasks 203. For example, if the inferred task 203 requires invoking a travel application 208 to book a rental car for travel between a default location and an event location, the mapping application 214 may display a preferred route and/or driving directions.

The personal assistant 200 also can access a user contact list 216. Contacts in the contact list may be associated with contact locations. In one embodiment, the set of customizable rules may require accessing the contact list 216 when the user default location and the event location differ according to predefined criteria. For example, the contact list 216 may be accessed to identify contacts located near the event location. The contact list 216 may also be accessed to determine event invitees, or potential event invitees. The customizable rules may require that when scheduling a remote event, contacts having a contact location near the remote event may be invited to the event, or that such contacts be identified as potential event invitees. For example, a list of potential invitees, having contact locations near the remote event, may be presented to the user for editing prior to transmission of invitations to the event.

The events added to the user calendar 201 by the personal assistant 200 can be called task defined events 204 since event parameters, such as event type, time, duration, attendees, invitees or location can be defined by the inferred tasks.

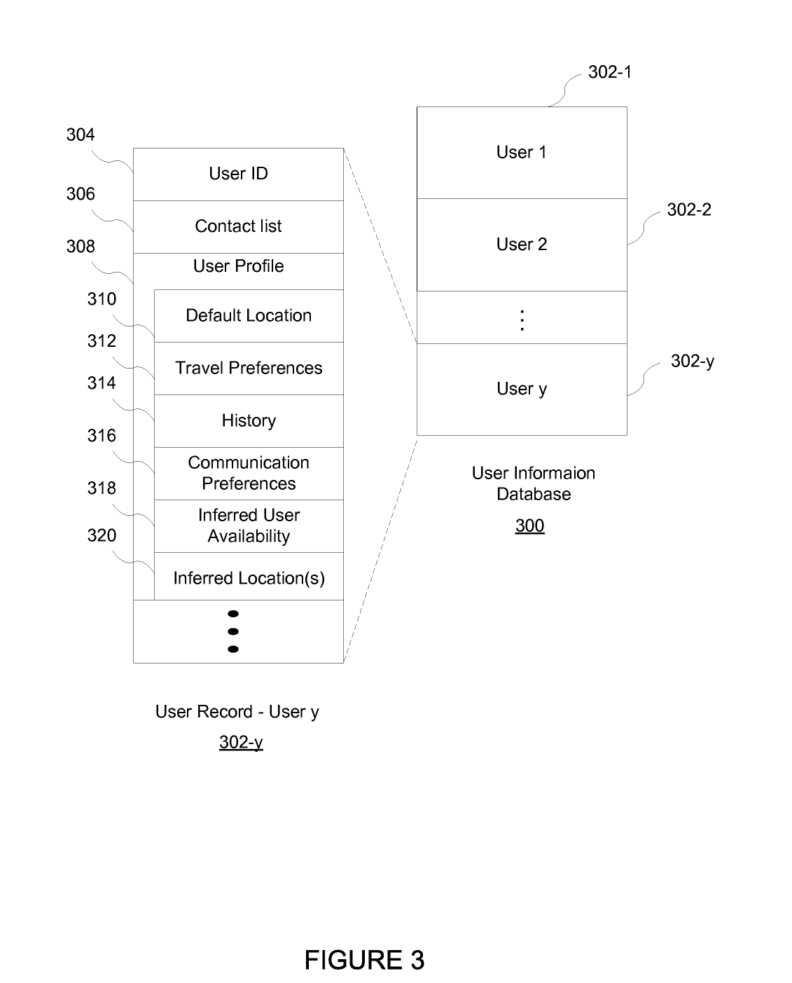

FIG. 3 is a block diagram of an exemplary user information database 300 having exemplary user records 302-1, 302-2 through 302-y according to some embodiments of the present invention. User information database 300 may represent, at least conceptually, the user information database 102 of the server system 101. However, in other embodiments, database 300 may also represent a local database at a client. User information database 300 stores user records 302, for example records for user 1 (302-1) through user y (302-y), where y may represent the number of users in the database.

A user record, for example user record 302-y, may include the following data or a subset or superset thereof:
a user ID 304 that uniquely identifies a particular user (for example, an n-bit binary number, where n is a whole number);
a contact list 306 that contains contact information for the user (contact information may include information about other system users or persons known to the user and take the form of a buddy list, address book or the like); alternatively, field 306 may contain a link to the user's contact list; and
a user profile 308 that provides additional information about the user.

The user profile 308 may contain the user's default location 310, travel preferences 312, history 314, communication preferences 316, inferred user availability 318, and inferred locations 320. In some embodiments some or all of data 310-320 may be stored in locations outside of the user profile 308, such as elsewhere in the user record 302 or in other databases or database partitions. In another embodiment, some or all of the information contained in the user record 302 may be maintained separately for each user at the user's client.

The user default location 310 may contain location information including geocoding specifying a particular geographic location and/or more general textual information, such as a place name, street address or the like. User travel preferences 312 may include preferred travel applications, preferred travel providers, preferred travel mode and the like. In some embodiments, travel preferences 312 include a set of rules associated with the user, which may be weighted according to a confidence rating based on user history. For instance, a set of travel rules associated with a user may set the user's preferred mode of travel to automobile when the distance to be traveled is less than 100 miles. If this preferred travel mode has been ratified by the user, the confidence rating may approach 100%.

User history 314 may include information associated with prior tasks invoked on behalf of the user, prior user actions using a mapping application, calendar or contact management application, or other archival information available to the system and associated with the user. User communication preferences 316 may include links or references to preferred communication applications, preferred communication times, preferred contacts, preferred communication mode, and the like. In some embodiments, communication preferences 316 include a set of rules associated with the user, which may be weighted according to confidence values, which in turn are based on user history. For instance, a set of communication rules associated with a user may set the user's preferred communication time to immediately follow the entry of a new calendar event. However, if the user frequently delays communication about a new calendar event, the confidence rating may approach 0%. The default location 310, travel preferences 312, and communications preferences 316 may be entered into the system 100 manually by the user or inferred based on available information and a customizable set of rules associated with the user.

Inferred user availability 318 may include times when the user may be in the office, at home, available by telephone, available by instant messaging, and the like. Inferred locations 320 may include geocoding for locations specified by the user by imprecise methods and user locations during times when a location is not specified by the user, such as between calendar events and the like. Inferred user availability 318 and inferred locations 320 may be determined by an inference engine according to a customizable set of inference rules as discussed herein.

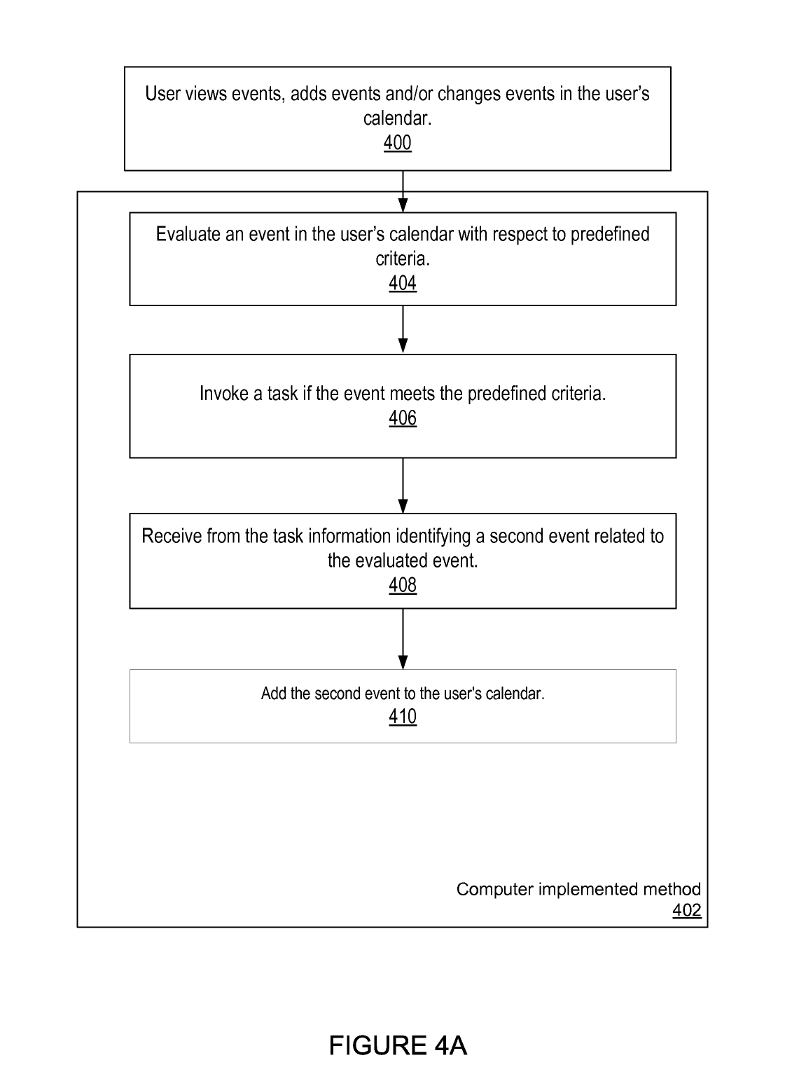

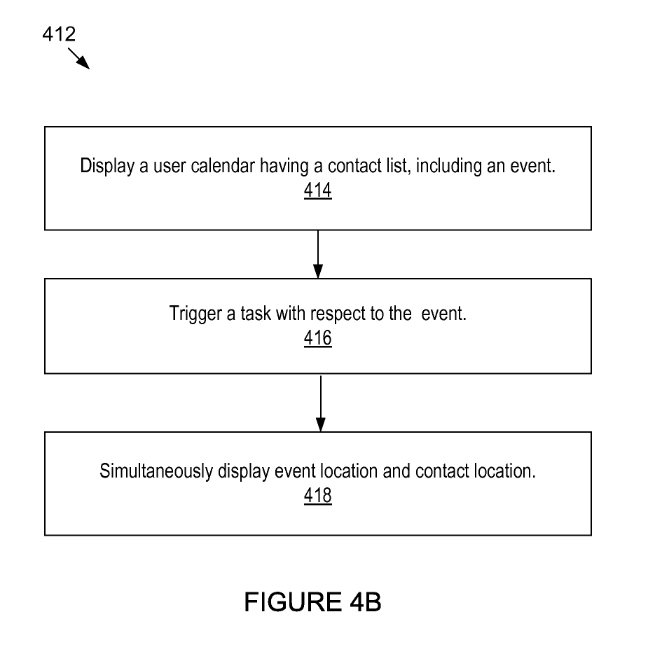

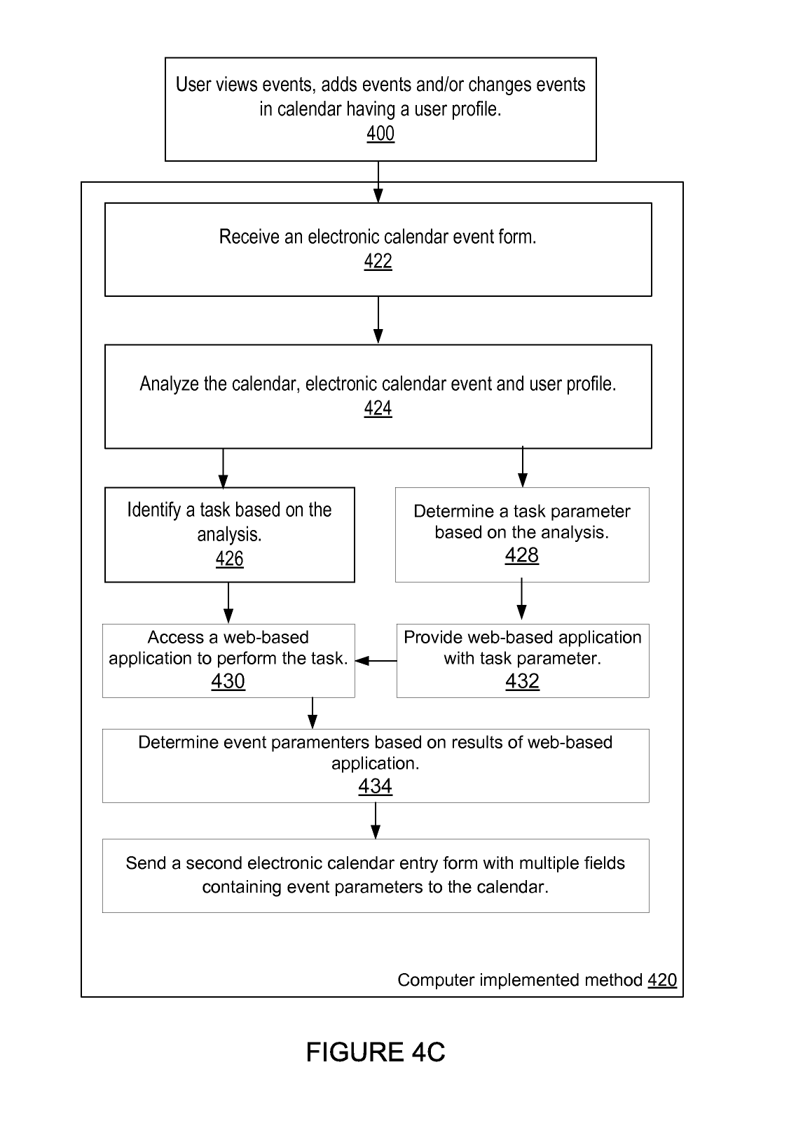

FIGS. 4A, 4B and 4C are flowcharts representing computer implemented methods according to various embodiments. FIGS. 4A, 4B and 4C show processes performed by the system 100. FIGS. 4A and 4C show processes performed in response to a user's actions 400 in a calendar. User actions 400 may include viewing a calendar event, adding an event to the user's calendar, changing a calendar event, or the like. This triggers the computer implemented method according to some embodiments.

FIG. 4A is a flow chart representing a computer implemented method 402 according to some embodiments. FIG. 4A shows that the computer implemented method 402 is triggered by the user's actions 400; however, in some embodiments the computer implemented method 402 may be initiated by the user. The computer implemented method 402 may be executed any number of times.

The computer implemented method 402 evaluates an event in the user's calendar with respect to predefined criteria 404. The event evaluated may be the event the user last acted upon or an event identified by the user. As discussed above, the predefined criteria may include a set of weighted rules customized for the user. The rules may be weighted by a confidence ratings, which in turn are based on history information or other user information. Evaluating the predefined criteria may include evaluating one or more existing events in the user's calendar. Evaluating the predefined criteria may include analyzing the user profile, the user location, the event location, and locations of at least some of the user's contacts. The user profile may include inferred user preferences based upon prior invocations of a task and/or prior iterations of the computer implemented method 402. In some embodiments the analysis of the user location and the event location may include a comparison of the user location and the event location. Evaluating the predefined criteria may also include evaluating history information. The history information may include task results from prior invocations of the task and method results from prior iterations of the computer implemented method 402. In some embodiments, evaluating the predetermined criteria may include defining a set of steps for invoking the task.

If the event meets the predefined criteria, the computer implemented method invokes a task 406. The computer implemented method 402 may also determine one or more parameters to supply to an application invoked by the task. For example, based on analyzing the user location and the event location, the computer implemented method may determine departure and arrival airports. This analysis may be based upon an analysis of geocodes associated with each location. As discussed above, invoking the task 406 may require invoking one or more applications, such as an application for making travel arrangements. In some embodiments, invoking the task 406 may require invoking a contact application for managing a set of contacts. The task may also require communicating with one or more of a user's contacts, so invoking the task 406 may also require invoking a communication application for communicating with at least some of the user contacts. In some embodiments, these functions may be performed by a contact management system. The task may also require displaying the location of one or more of a user's contacts, so invoking the task 406 may also require invoking a mapping application in order to map contact locations. Once the task has been invoked, the user may or may not interact with the applications to complete the task. For example, the user may confirm information supplied by the task to the application within an application form, which may in turn affect the confidence rating of the rule.

Upon completion of the task, the computer implemented method 402 may receive from the task information identifying a second event related to the evaluated event 408. The second event may be, for example a travel event, such as a flight, a meeting event or any other event associated with the first event. The computer implemented method 402 then adds the second event to the user's calendar 410.

FIG. 4B is a flow chart representing a computer implemented method 412 according to some embodiments. The computer implemented method 412 may be executed any number of times. The computer-implemented method 412 displays a user calendar, including a calendar event 414. The computer implemented method 412 then triggers a task with respect to the calendar event 416. The task may include simultaneously displaying an event location and contact location 418 for one or more contacts, where event location includes information associated with the respective calendar event and contact location includes information associated with a contact in the user's contact list. In some embodiments of the computer implemented method 412 the task derives the contact location from information in the contact's calendar. The task may also include using a mapping application to simultaneously display the event location and the contact location. In some embodiments the task may include displaying information about contacts in the user's contact list that meet location criteria related to the calendar event.

In other embodiments, a computer implemented method displays a user calendar, including a calendar event, triggers a task with respect to the calendar event, using a mapping application to simultaneously display event location and contact location, and adding a meeting event to the calendar for a meeting with at least one of the contacts in the set of contacts. The task may include notifying a number of the contacts in the contact list according to predetermined criteria. In some embodiments, the task includes rescheduling a conflicting calendar event according to predetermined criteria, or suggesting to the user the rescheduling of a conflicting calendar event according to predetermined criteria.

FIG. 4C is a flow chart representing a computer implemented method 420 according to some embodiments. FIG. 4C shows that the computer implemented method 420 is triggered by the user's actions 400; however, in some embodiments the computer implemented method 420 may be initiated directly by the user. The computer implemented method 420 may be executed any number of times.

The computer-implemented method 420 includes receiving an electronic calendar event form 422. The calendar event form 422 is associated with a user's calendar. Then computer-implemented method 420 analyzes the calendar, calendar event, and user profile 424. Based on that analysis, the computer-implemented method 420 identifies at least one task 426 and determines a task parameter for the task 428. Once the task is identified 426, the computer implemented method 420 accesses an online or web-based application to perform the task 430. The computer implemented method 420 also provides the online or web-based application with the task parameter 432.

Optionally, the computer implemented method 420 may determine event parameters based on the results obtained from the web based application 434. The computer implemented method 420 sends a second electronic calendar entry form to the calendar 436. The second electronic calendar entry form may have multiple fields containing the event parameters.

In accordance with some embodiments, a system for integrated time and place management includes memory, one or more processors, and one or more programs stored in the memory and configured for execution by the processors. The system may include the client 112, the server system 101, or both. The programs include instructions for evaluating an event associated with a calendar, invoking a task if the event meets predefined criteria, receiving, from the task, information identifying a second event related to the first event, and adding the second event to the calendar.

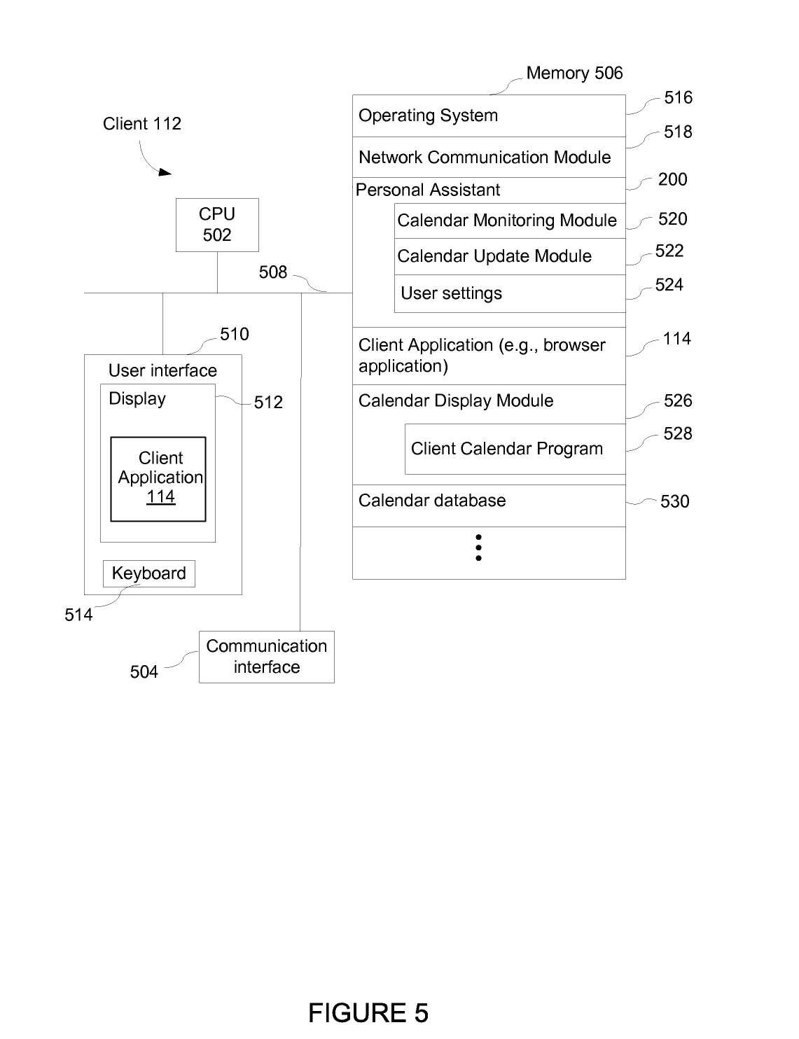

FIG. 5 is a block diagram of an exemplary client 112 in accordance with some embodiments of the present invention. The client 112 typically includes one or more processing units (CPUs) 502, one or more network or other communications interfaces 504, memory 506, and one or more communication buses 508 for interconnecting these components. The communication buses 508 may include circuitry (sometimes called a chipset) that interconnects and controls communications between system components. The client 112 optionally may include a user interface 510 comprising a display 512 and a keyboard 514. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPU(s) 502. In some embodiments, memory 506 stores the following programs, modules and data structures, or a subset thereof:
an operating system 516 that includes procedures for handling various basic system services and for performing hardware dependent tasks;
a network communication module 518 that is used for connecting the client 112 to other computers via the one or more communication network interfaces 504 and one or more communication networks, such as the Internet, other wide area networks, local area networks, metropolitan area networks, and the like;
a client application 114 (e.g., a browser application) that can permit a user to view and/or interact with various resources (e.g., web pages, online resources at remotely located host computers, etc.) as described above;
a local calendar database 530 for storing calendar information;
a calendar display module 526 for displaying calendar information; and
a personal assistant 200 that can evaluate information, infer and invoke tasks based on that evaluation and add events to the calendar based on the results of those inferred tasks, as described above.

In some embodiments, the personal assistant 200 may include a calendar monitoring module 520, a calendar update module 522 and user settings 524. The calendar monitoring module 520 monitors information being entered into the calendar database. The calendar update module 522 is for adding events to the calendar database. The user settings 524 include a personalized set of rules that govern the inferences made by the personal assistant 200. In some embodiments, the user settings 524 may include a weight for some or all of the personalized set of rules based upon the user's prior actions.

In some embodiments, the personal assistant 200 is a computer program product for use in conjunction with a computer system, where the computer program product includes a computer readable storage medium and a computer program mechanism embedded therein. The computer program mechanism comprises instructions for evaluating an event associated with a calendar, for invoking a task if the event meets predefined criteria, for receiving, from the task, information identifying a second event related to the first event, and for adding the second event to the calendar.

The calendar display module 526 enables the display of calendar information. For example, a user may select a particular segment of time to view, such as the month of October 2007, and the calendar display module 526 will allow the display 512 to show a graphical representation of the month and calendar events scheduled during that month. The calendar display module 526 may include a client calendar program 528 in some embodiments.

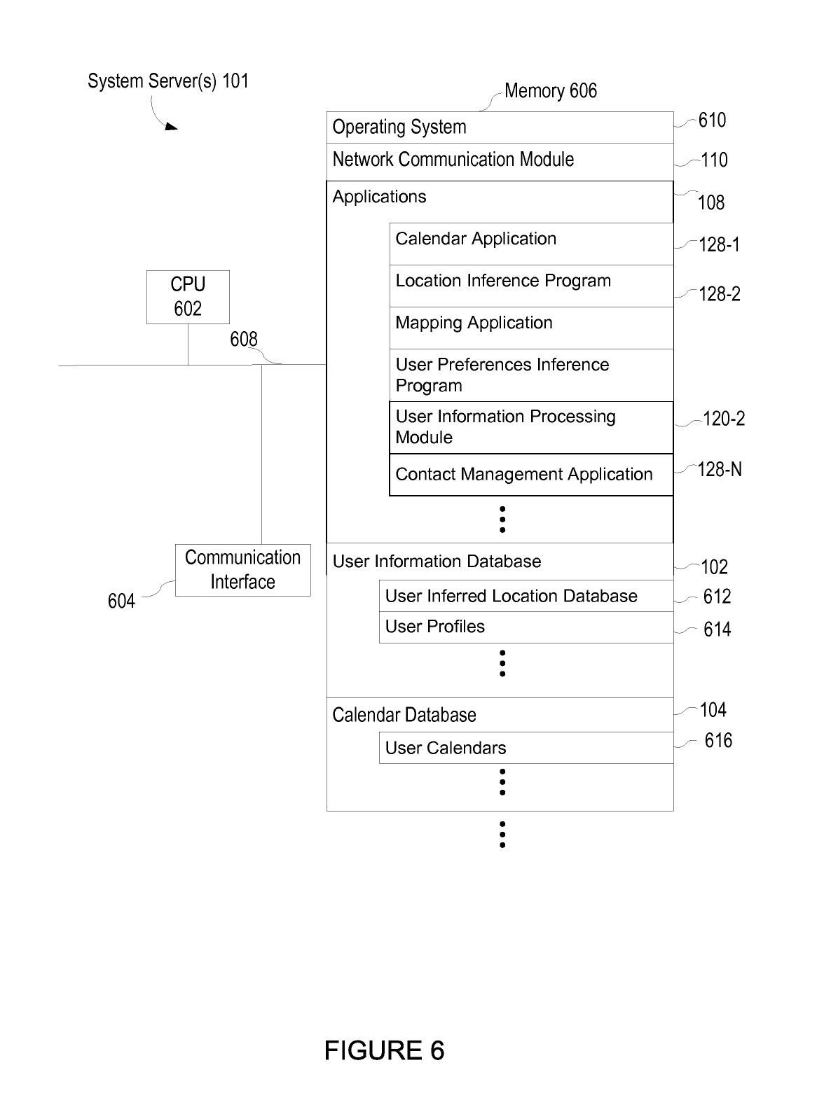

FIG. 6 is a block diagram of an exemplary server system 101 in accordance with some embodiments of the present invention. The server system 101 typically includes one or more processing units (CPUs) 602, one or more network or other communication interfaces 604, memory 606, and one or more communication buses 608 for interconnecting these components. The communication buses 608 may include circuitry (sometimes called a chipset) that interconnects and controls communications between system components. The server system 101 optionally may include a user interface (not shown). Memory 606 includes high-speed random access memory, such as DRAM, SRAM, DDR RAM or other random access solid state storage devices; and may include non-volatile memory, such as one or more magnetic disk storage devices, optical disk storage devices, flash memory devices, or other non-volatile solid state storage devices. Memory 606 optionally includes one or more storage devices remotely located from the CPU(s) 602. In some embodiments, memory 606 stores the following programs, modules, and data structures, or a subset thereof:
an operating system 610 that includes procedures for handling various basic system services and for performing hardware dependent tasks;
a network communication module 110 that is used for connecting the server system 101 to other computers via the one or more communication network interfaces 604 and one or more communication networks, such as the Internet, other wide area networks, local area networks, metropolitan area networks, and so on;
applications 108;
a user information database 102; and
a calendar database 104.

As described above, the network communication module 110 facilitates communication between the server system 101 and the communication network 111. The network communication module 110 allows for the transfer of information from the server system 101 to the communication network 111 so that the information may be displayed on the client application 114 of the client 112.

The user information database 102 stores user information associated with each user of the system. User information can include a user inferred location database 612, user profiles 614, user contact lists, user IDs, and rules associated with the user. User profiles 614 can include a default location, travel preferences, history, communication preferences, and inferred availability. The user inferred location database 612 stores location inferences associated with each user. The location inferences may be weighted according to a confidence level based on user acceptance of an inferred location. Location inferences may also geolocation coding, or geocoding, along with text based or other location information. The calendar database 104 stores calendar information associated with one or more user calendars 616. Calendar information can include data associated with a particular event in a user's calendar, such as event time, event date, event location, event description, event attendees and event invitees. Calendar information can also include metadata, such as geocoding.

Each of the above identified elements in FIGS. 5 and 6 may be stored in one or more of the previously mentioned memory devices, and corresponds to a set of instructions for performing a function described above. The above-identified modules or programs (i.e., sets of instructions) need not be implemented as separate software programs, procedures or modules, and thus various subsets of these modules may be combined or otherwise rearranged in various embodiments. In some embodiments, memory 506 and 606 may store a subset of the modules and data structures identified above. Furthermore memory 506 and 606 may store additional modules and data structures not described above.

Although FIGS. 5 and 6 show respectively a client 112 and a server system 101, the figures are intended more as functional descriptions of the various features which may be present in a client and set of servers than as a structural schematic of the embodiments therein. In practice, and as recognized by those of ordinary skill in the art, items shown separately could be combined and come items could be separated. For example, some items shown separately in FIG. 6 could be implemented on a single server and single items could be implemented by one or more servers. The actual number of servers used to implement server system 101 and how features are allocated among them will vary from one implementation to another, and may depend in part on the amount of data traffic that the system must handle during peak usage periods as well as during average usage periods.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer-implemented method, comprising:
at a client system with one or more processors and memory storing one or more programs for execution by the one or more processors, the one or more programs including a first application having instructions that when executed by the client system cause the client system to perform the method:
evaluating a first event from a user's electronic calendar according to predefined criteria, wherein evaluating the first event from a user's electronic calendar according to the predefined criteria includes analyzing a user location, associated with the user, and an event location, associated with the first event, wherein the user location and the event location each have an associated geocode, and analyzing the user location and the event location includes analyzing the associated geocodes and determining that the geocode associated with the event location of the first event is different from the geocode associated with the user location;
in accordance with a determination that the first event meets the predefined criteria, invoking, for execution by the client system, a software application, distinct from the first application, wherein the software application is an application for making travel arrangements;
receiving, from the software application, information identifying a second event related to the first event, wherein the second event comprises a travel event of the user;
adding the second event to the user's electronic calendar as a scheduled event of the user; and
displaying the user's electronic calendar, including the second event.

2. (canceled)

3. (canceled)

4. (canceled)

5. (canceled)

6. (canceled)

7. The method of claim 1, wherein adding the second event comprises adding a meeting event associated with the first event.

8. The method of claim 1, wherein evaluating the first event includes analyzing a location, associated with the user and the first event, in combination with respective contact locations of a plurality of contacts of the user.

9. The method of claim 1, further comprising evaluating a plurality of events from the user's electronic calendar according to the predefined criteria.

10. The method of claim 1, wherein evaluating the first event from a user's electronic calendar according to the predefined criteria includes evaluating history information comprising task results from prior invocations of the software application.

11. The method of claim 10, wherein evaluating the first event from a user's electronic calendar according to the predetermined criteria includes evaluating a personalized set of rules associated with the user and defining a set of steps for invoking the software application, wherein the personalized set of rules is weighted by history information of the user's prior actions.

12. The method of claim 1, wherein evaluating the first event from a user's electronic calendar according to the predefined criteria includes analyzing a user profile of the user.

13. The method of claim 12, wherein the user profile includes one or more inferred user preferences based upon at least one prior invocation of the software application.

14. The method of claim 1, wherein evaluating the first event from a user's electronic calendar according to the predefined criteria includes comparison of a user location associated with the user, and an event location, associated with the first event.

15. (canceled)

16. The method of claim 1, wherein the first application supplies at least one task parameter to the software application, based on analyzing the user location and the event location.

17. (canceled)

18. The method of claim 1, wherein the first application supplies at least one task parameter to the software application, based on analyzing the associated geocodes.

19. (canceled)

20. (canceled)

21. (canceled)

22. (canceled)

23. (canceled)

24. (canceled)

25. (canceled)

26. (canceled)

27. A non-transitory computer readable storage medium storing one or more programs to be executed by a computer system, the one or more programs including a first application comprising:
instructions for evaluating a first event from a user's electronic calendar according to predefined criteria, wherein the instructions for evaluating the first event from a user's electronic calendar according to the predefined criteria include instructions for analyzing a user location, associated with the user, and an event location, associated with the first event, and wherein the user location and the event location each have an associated geocode, and analyzing the user location and the event location includes analyzing the associated geocodes and determining that the geocode associated with the event location of the first event is different from the geocode associated with the user location;
instructions for, in accordance with a determination that the first event meets the predefined criteria, invoking, for execution by the computer system, a software application, distinct from the first application, wherein the software application is an application for making travel arrangements;
instructions for receiving, from the software application, information identifying a second event related to the first event, wherein the second event comprises a travel event of the user;
instructions for adding the second event to the user's electronic calendar as a scheduled event of the user; and
instructions for displaying, at the computer system, the user's electronic calendar, including the second event.

28. A computer system for managing time and place information, comprising:
memory;
one or more processors;
one or more programs stored in the memory and configured for execution by the one or more processors, the one or more programs including a first application having:
instructions for evaluating a first event from a user's electronic calendar according to predefined criteria, wherein the instructions for evaluating the first event from a user's electronic calendar according to the predefined criteria include instructions for analyzing a user location, associated with the user, and an event location, associated with the first event, and wherein the user location and the event location each have an associated geocode, and analyzing the user location and the event location includes analyzing the associated geocodes and determining that the geocode associated with the event location of the first event is different from the geocode associated with the user location;
instructions for, in accordance with a determination that the first event meets the predefined criteria, invoking, for execution by the computer system, a software application, distinct from the first application, wherein the software application is an application for making travel arrangements;
instructions for receiving, from the software application, information identifying a second event related to the first event, wherein the second event comprises a travel event of the user;
instructions for adding the second event to the user's electronic calendar as a scheduled event of the user; and
instructions for displaying, at the computer system, the user's electronic calendar, including the second event.

29. (canceled)

30. (canceled)

31. The computer readable storage medium of claim 27, further comprising instructions for evaluating a plurality of events from the user's electronic calendar according to the predefined criteria.

32. The computer readable storage medium of claim 27, wherein the instructions for evaluating the first event from a user's electronic calendar according to the predefined criteria include instructions for analyzing a user profile of the user, the user profile including one or more inferred user preferences based upon at least one prior invocation of the software application.

33. (canceled)

34. The computer readable storage medium of claim 27, the first application further comprising instructions for supplying at least one task parameter to the software application based on analyzing the user location and the event location.

35. (canceled)

36. (canceled)

37. The computer system of claim 28, further comprising instructions for evaluating a plurality of events from the user's electronic calendar according to the predefined criteria.

38. The computer system of claim 28, wherein the instructions for evaluating the first event from a user's electronic calendar according to the predefined criteria include instructions for analyzing a user profile of the user, the user profile including one or more inferred user preferences based upon at least one prior invocation of the software application.

39. (canceled)

40. The computer system of claim 28, the first application further comprising instructions for supplying at least one task parameter to the software application based on analyzing the user location and the event location.
